(19) United States
(12) Patent Application Publication
(10) Pub. No.: US 2006/0250364 A1
(43) Pub. Date: Nov. 9, 2006

(54) Ergonomic computer mouse

(76) Inventor: Alex Gorbunov, Moscow (RU)

Correspondence Address: WILLIAM COLLARD;COLLARD & ROE, P.C., 1077 NORTHERN BOULEVARD, ROSLYN, NY, 11576, US

(21) Appl. No.: 11/125,279

(22) Filed: May 9, 2005

(51) Int. Cl. G09G 5/08

(52) U.S. Cl. 345/163

(57) ABSTRACT

An ergonomic computer mouse designed for the left hand, has a palm operated inputting device that alleviates the strain placed on a right hand and right hand's fingers. The device is motionless and does not contain a sensor for positioning the cursor, as with an ordinary mouse, and is operated by the user's left palm for selection functions such as clicking and double clicking operations. The user uses the ordinary mouse in his right hand only for positioning the cursor. The mouse has a big button, ergonomically shaped to fit the user's hand in a naturally relaxed position. Operations as “click” and “double click” are fulfilled by the palm of the left hand: a slight shifting of user's palm generates clicks and double-clicks, where the user clicks only once to generate a double click.

### BACKGROUND OF THE INVENTION

1. Field of the Invention

A computer ergonomic mouse is provided that works in combination with an any ordinary mouse, trackball, or touch-pad. The ergonomic mouse allows for a user's hands to remain in a relaxed position close to a state of repose, while making positioning and clicking operations, because it gives to user the opportunity to work with both palms, instead of one index finger of right hand, as with conventional mice.

2. The Prior Art

In today's modern society, the potential for development of Repetitive Strain Injury (RSI) is everywhere. In fact, anyone who works at a computer is at risk for developing a RSI. The thousands of repeated keystrokes and long periods of gripping and dragging with a computer mouse slowly causes strain and eventually can result in injury and inflammation.

Anyone who experiences pain or loss of feeling in the hands or wrists may have some degree of RSI, especially if the symptoms are associated with repetitive tasks, such as clicking mouse buttons.

Some computer users have seriously injured themselves by “working through their pain”.

Most spread types of RSI for computer users are: Carpal Tunnel Syndrome (CTS), and “trigger finger”. CTS, also known as tardy median nerve palsy, is a mechanical malfunction of the hand and wrist resulting from repetitive finger movements. CTS results from adverse stress on the median nerve.

“Trigger finger”, also known as stenosing tenosynovitis is caused by a thickening on the tendon catching as it runs in and out of the sheath. In many cases, this condition may be the result of repeated strain of this area due to repetitive finger movements. Finally, the fingers becomes locked in the bent position and cannot be unlocked any more.

In some cases, only surgery can help. However only 23% of all Carpal Tunnel patients are able to return to their profession, following surgery. In addition, 36% of Carpal Tunnel patients need constant medical treatment. CTS is a debilitating decease that produces a lot of pain.

To avoid injury in both cases—for CTS as well as for “trigger finger”—it is extremity helpful to prevent hands from frequent finger movements, which computer users may undergo for many hours a day.

Unfortunately, many modern computer interface systems and programs work using multiple “clicks”, “double clicks”, or “drag and drop” operations, which require constant use of the fingers, especially the index finger.

Thus, during one's career, a computer user may make more than 20,000,000 click operations using fingers. Most computer users “click” from 5,000 to 10,000 times per day, with their index finger only.

In addition, the user unconsciously tends to grip the mouse when operating and pressing the buttons. This occurs more frequently among children or teenagers playing computer games.

Most computer input devices are operated by a single hand. Efforts to make ergonomic input devices concentrate on improving the shape of the mouse or other input device, providing a more comfortable fit for the hand. There are more than 50 patents relating to ergonomic mice. However, the buttons and position control are still operated by the same hand: A sensor (optical and laser for modern computer mice, ball for previous models) is situated on the same computer ergonomic mouse, as well as buttons to make “click”, “double-click”, “drag” etc. operations.

But if a positioning sensor is situated into the unit, then people cannot relax their hand while it is resting on the unit, as there would be the need to “control” and “grip” the mouse to prevent the cursor from moving (especially when attempting to click). This is the essence of the problem with most mice—when using the mouse, the user has to keep a device—which is designed to move smoothly and freely—from moving at all, hundreds and thousands of times a day (i.e. whenever user is clicking a target).

U.S. Pat. No. 5,886,685 discloses a device that is operated by the user's foot. This device does not require use of the hands for positioning the cursor or “clicking”. However, hand-operated devices are more regularly used in the market. In addition, foot-based operations require extra skills to work, and are not as precise as hand-operated systems.

Most input devices are activated by the fingertips of the hand, while the other hand is relaxed. To take the strain off the one hand, a device allowing both hands to operate would be advantageous. U.S. Pat. No. 5,990,871 shows a trackball input device designed for children that allows the use of both hands. Since this device is operated by both hands, the buttons can be pressed by either hand. This single-unit design is oriented for children and does not allow for accurate positioning and is cumbersome for adults.

### SUMMARY OF THE INVENTION

The present computer ergonomic mouse is designed for the left hand, and is a palm operated inputting device, that alleviates the strain placed on a right hand and right hand's fingers. The device is motionless and does not contain a sensor for positioning the cursor, as with an ordinary mouse, and is operated by the user's left palm for clicking and double clicking operations. The user uses the ordinary mouse in his right hand only for positioning the cursor.

The present computer ergonomic mouse has a big button, ergonomically shaped to fit the user's hand in a naturally relaxed position. Selection operations as “click” and “double click” are fulfilled by the palm of the left hand: a slight shifting of the user's palm generates clicks and double-clicks.

In an ordinary one-handed mouse, people cannot relax their hand while it rests on the unit, as there would be the need to “control” and “grip” the mouse to prevent the cursor from moving, especially when attempting to click.

It is only by having a stationary fixed device with a palm click button that the hand and fingers remain in a relaxed position, permitting clicking actions without any gripping force or strain.

There is a need to design a product that can move without effort and which must not be moved whenever a target has been obtained. This can only be accommodated through the control afforded by static force of the hands and fingers.

This is what present computer ergonomic mouse does—allow free relaxed movement with one hand, and relaxed clicking which can't affect cursor movement with the other hand.

In a preferred embodiment, there are adjustable force settings. The user can adjust the actuation force of the unit from 10 grams to 300 grams, creating as light or as strong a touch as required. In another preferred embodiment, a wheel can be added to allow for screen scrolling. The buttons can be programmable for additional functions as well.

The ergonomic mouse according to the invention can be very useful for CAD drawers, architects, and injured workers, in modifying their work sites to enable them to return to work and to remain working, and can be used even by quadriplegics taking a computer course.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1. shows the present computer ergonomic mouse and it's functions;

FIG. 2. shows the view from above on the present computer ergonomic mouse;

FIG. 3. shows a front perspective view of the invention in conjunction with the ordinary mouse;

FIG. 4. explains what is happening in the hands, when user uses ordinary input device in conjunction with present computer ergonomic mouse;

FIG. 5. explains what is happening in the hand, when user uses ordinary input device;

FIG. 6. shows one of several possible mechanisms for the adjustable force settings; and

FIG. 7. shows another embodiment of possible mechanisms for the adjustable force settings.

### DETAILED DESCRIPTION OF PREFERRED EMBODIMENTS

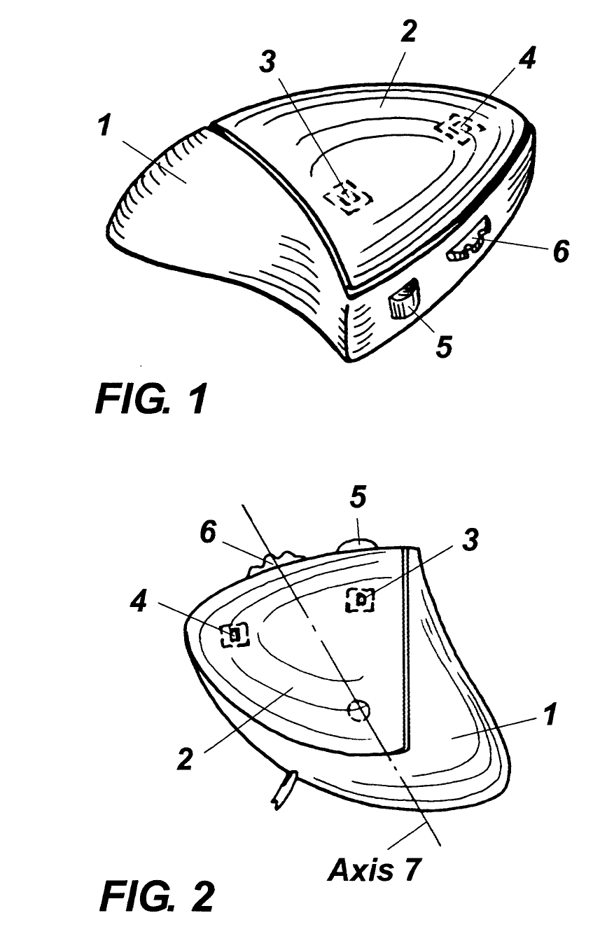

Referring now in detail to the drawing and in particular FIGS. 1 and 2, there is shown view of the device, consisting of: base 1, that is put on the desk and stationary on a desk. There is a rocking button 2, for the palm of the left hand, which covers this button fully. Button 2 is large enough so it can be pressed by user's palm.

There are 2 small buttons under big button 2—one to make a “left click” (small button is in place 3) and one to make a “double click” (small button is in place 4), designed so that the user need to click only once (in an ordinary mouse, the user needs to click two times to initiate a “double click”).

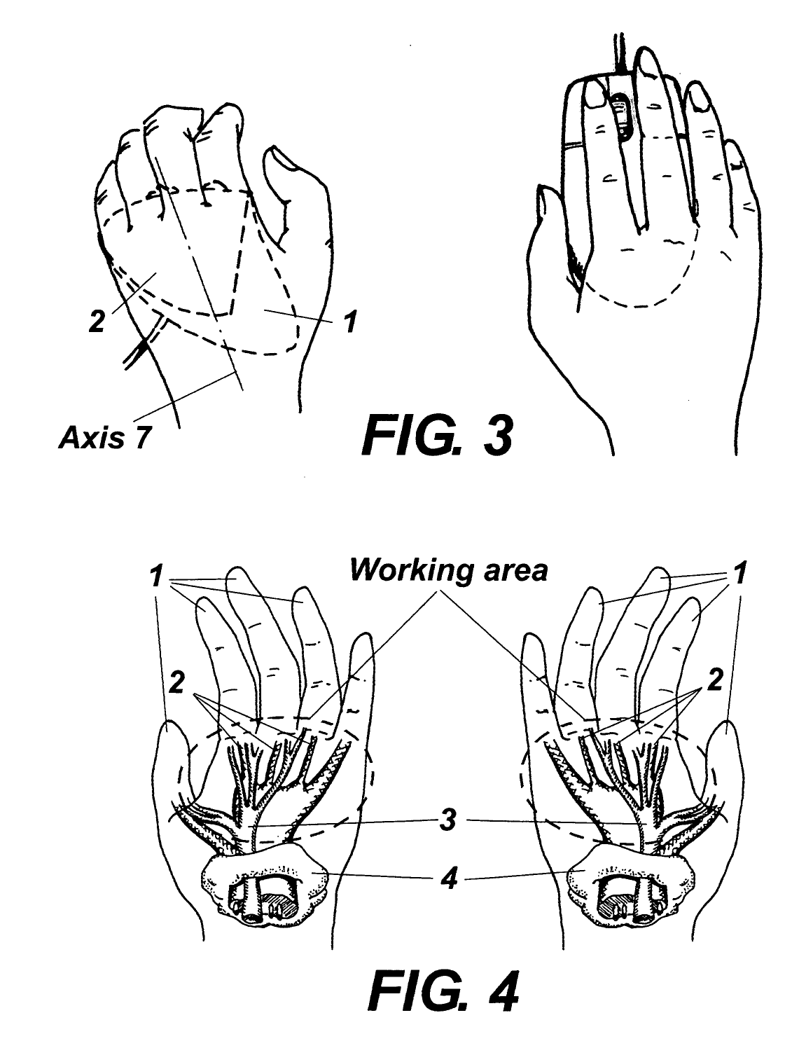

The left hand and fingers remain in a relaxed position, permitting clicking actions without any gripping force or strain. Operations such as “click” and “double click” are fulfilled by the palm of the left hand: A slight angular shifting of the user's palm generates clicks (when user presses with the palm in place 3) and double-clicks (when user presses with the palm in place 4). Shifting of the button 2 happens around the axis 7 (FIG. 3): so it is not possible to press buttons 3 and 4 simultaneously. only one of buttons 3 and 4 at one time.

There is also a small button 5, located on the side of base 1, that is equal to the “right click” of the ordinary mouse. A conventional screen-scrolling wheel (not shown) can also be installed on base 1.

There is a very useful embodiment of the current ergonomic mouse with a lifting springs-containing mechanism that allows one to adjust the actuation force with which the user presses the buttons. It was found that a good range for adjustment is from 10 grams to 300 grams. (In all presently used computer mice, there is no adjustable mechanism, the clicking force is fixed). In this way, by rotating the adjustable wheel 6 CW and CCW by a finger, the user can adjust the present ergonomic mouse to click softer or harder.

By trying different actuation forces and rotating the wheel, the user can locate the position where he feels the right “touch” or mixture of tactility and comfort.

It is recommended that the user adjust the actuation force, depending on the weight of his palm and own feeling. Thus, the user's hand remains in a naturally relaxed position, while the palm only slightly shifts, generating a “right click” or “double click” (as one click).

By being combined with an ordinary mouse via a USB port (Wi-Fi, Blue Tooth, Radio-Interface or other connecting interface), the present ergonomic mouse allows a user to work with both hands (mainly by palms), having palms that remain in a naturally relaxed position: the right palm on the ordinary mouse is used for the positioning cursor only, and the left hand palm on the ergonomic mouse according to the invention is used for “click” and “double click” (as one click) operations. (FIG. 3)

Thus no gripping is required, and the hands relax when using the mouse.

FIG. 4. shows how hands work with the present ergonomic mouse along with a mouse for the right hand: fingers 1 and its tendons 2 are not involved in any job, only the palms of both hands. Therefore, there is no gripping or work that the fingers need to do. Therefore, tendons do not work, and cannot enlarge their size and cannot squeeze median nerve 3 in the narrow carpal tunnel 4. Therefore, there is no probability of developing CTS or “trigger finger” disease.

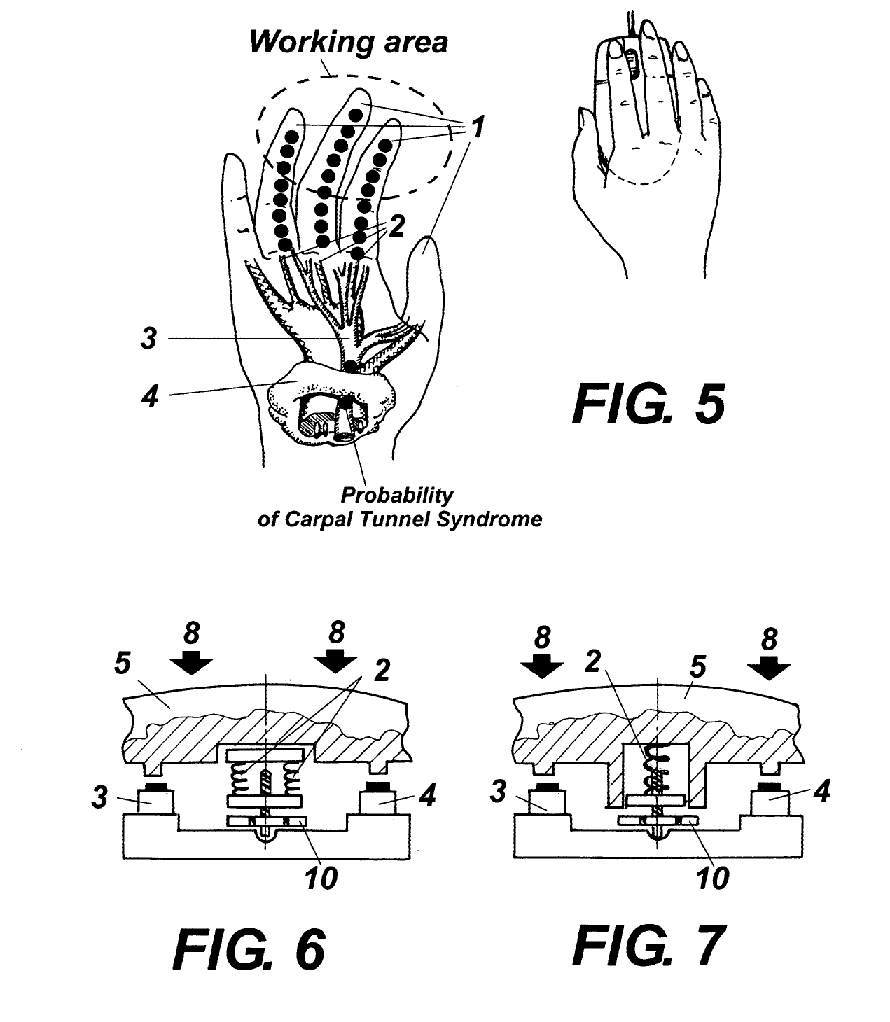

Vice versa, FIG. 5. shows what is happening in a user's hand, when a user uses an ordinary mouse for the right hand. The user needs to grip the mouse with the fingers to position the cursor, and to make “clicks”. The user cannot relax their hand while it rests on the computer mouse, as there would be the need to “control” and “grip” the mouse to prevent the cursor from moving (especially when attempting to click). Also, the user makes clicks and double clicks (pressing twice on the button with index finger). All these can lead to problems in the hands, and CTS and/or “trigger finger” can appear, because tendons do repetitive work (10,000-20,000 times a day), that over time leads to enlarging of finger tendons' size and can squeeze median nerve 3 in the narrow carpal tunnel 4.

FIG. 6. and FIG. 7. show an adjustable mechanism according to the invention in two possible embodiments. Wheel 10 rotates by a finger and moves springs 2 (or one spring in FIG. 7) up and down. It leads big button 5 (Button 2 on FIGS. 1 and 2) to swing softer or harder, to adjust the effort applied by a user's palm (arrow 8) to press the button 3 or the button 4.

Accordingly, while only a few embodiments of the present invention have been shown and described, it is obvious that many changes and modifications may be made thereunto without departing from the spirit and scope of the invention.

What is claimed is:

1. An ergonomic computer mouse designed for use in a user's left hand, comprising:
a motionless base having a first button designed to fit fully in a user's left palm, said base adapted to be fixed on a work surface; and
a plurality of smaller buttons situated underneath said first button;
wherein the base has no sensor for positioning a cursor and wherein selection functions of the mouse are accomplished by a slight shifting of the user's palm on the first button to depress one of the smaller buttons underneath the first button.

2. The mouse according claim 1, further comprising an adjustable mechanism for adjusting actuation force required to make selection functions.

3. The mouse according claim 1, further comprising an extra button on a side of the base to activate a “right click” function or another programmable function.

4. The mouse according claim 1, wherein all of said buttons are programmable for desired functions.

5. The mouse according to claim 1 further comprising a wheel on said base or said first button, said wheel controlling screen scrolling functions.

6. The mouse according to claim 1, wherein the first button is mounted to the base along a rocking axis and wherein there are two buttons under the first button, said two buttons being located one each on opposite sides of the axis, so that the first button may be depressed on only one side of the rocking axis at one time and allows only one of said two buttons to be depressed at any one time.
